(19) United States
(12) Patent Application Publication
(10) Pub. No.: US 2011/0099757 A1
(43) Pub. Date: May 5, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/633,667

(22) Filed: Dec. 8, 2009

(30) Foreign Application Priority Data
Oct. 30, 2009 (CN) 200920313777.8

(51) Int. Cl. E05D 11/10; E05F 1/08

(52) U.S. Cl. 16/297; 16/319

(57) ABSTRACT

A hinge includes a shaft, a rotation bracket rotatably mounted to the shaft, an interference element fixedly mounted to the shaft, a biasing member mounted to the shaft, and a fastener fixed to a distal end of the shaft. The rotation bracket includes a combination portion engaging and capable of rotating relative to the interference element. The interference includes a first end surface located on a first cone angling down from a center towards a side of the first end surface, the combination portion includes a second end surface located on a second cone angling down from a side towards a center of the second end surface, to engage the first end surface of the interference element.

### CROSS-REFERENCE TO RELATED APPLICATION

This relevant subject matter is disclosed in a co-pending U.S. patent application (Attorney Docket No. US29560) filed on the same date and entitled “HINGE”, which is assigned to the same assignee as this patent application.

### BACKGROUND

1. Technical Field

The present disclosure relates to a hinge.

2. Description of Related Art

A collapsible device, such as a notebook computer, or a clamshell mobile phone, generally includes a base, and a cover pivotally hinged on the base and covering a surface of the base. The hinge generally includes a male interference element and a female interference element for positioning the cover during rotation. The male interference element includes two raised portions and the female interference element includes two depressed portions for receiving the raised portions. When the male interference element is rotated relative to the female interference element, the raised portions are withdrawn from the corresponding depressed portions, resulting in friction between the first and second elements, resulting ion wear on the male and female interference elements. In this process, the male and female interference elements require constant contact with each other for smooth operation, but after a period of use, they can wear down and lose contact with each other, causing misoperation of the collapsible device.

### BRIEF DESCRIPTION OF THE DRAWINGS

FIG. 1 is an exploded, isometric view of an exemplary embodiment of a hinge, the hinge including a rotation bracket and an interference element.

FIG. 2 is similar to FIG. 1, but viewed from another perspective.

FIG. 3 is an exploded, enlarged view of the rotation bracket and the interference element of FIG. 1.

FIG. 4 is an assembled, isometric view of the hinge of FIG. 1.

FIG. 5 is a sectional, assembled view of the rotation bracket and the interference assembly of the hinge of FIG. 1.

### DETAILED DESCRIPTION

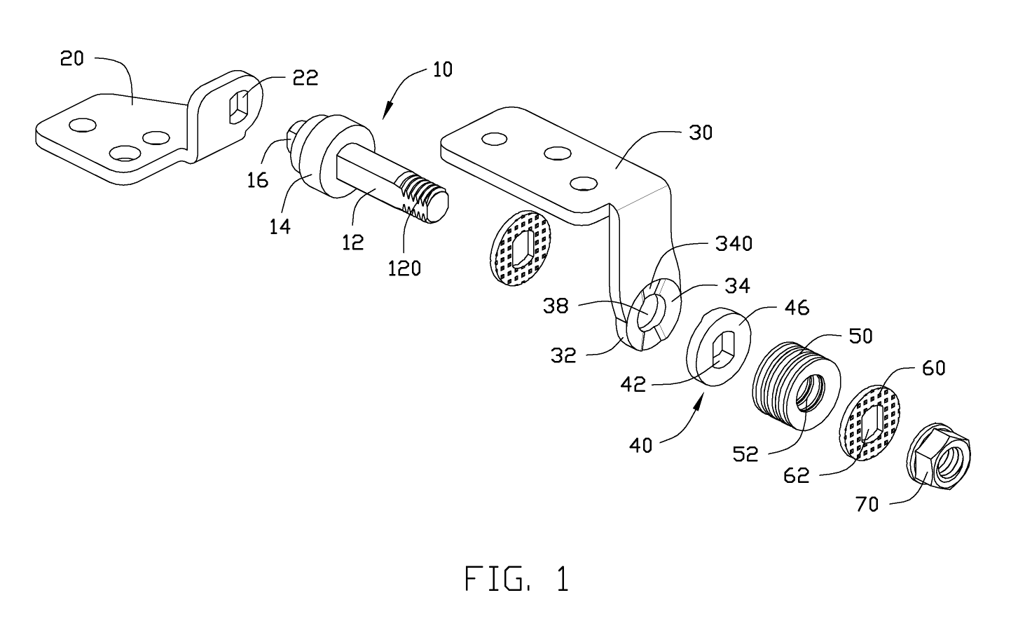

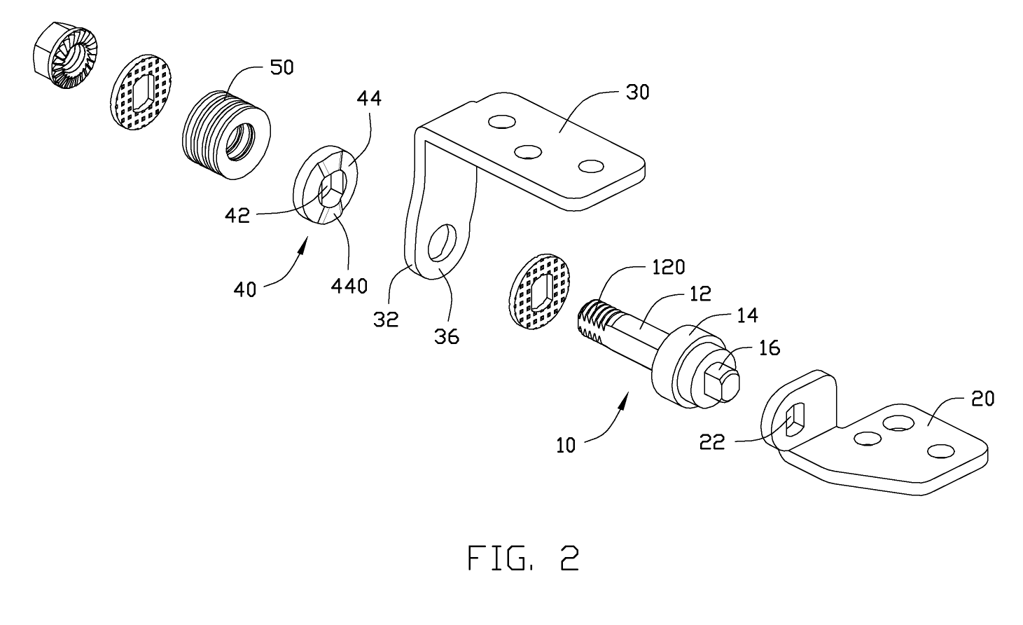

Referring to FIGS. 1 and 2, an exemplary embodiment of a hinge includes a shaft 10, a fixing bracket 20, a rotation bracket 30, an interference element 40, a biasing member 50, two washers 60, and a fastener 70.

The shaft 10 includes a fixing rod 12 having a substantially double-D shaped cross-section. A first end of the fixing rod 12 forms a threaded portion 120, and a second end of the fixing rod 12 opposite to the first end forms a combination block 16. A circular protrusion 14 protrudes from a circumference of the fixing rod 12, adjacent to the combination block 16.

The fixing bracket 20 defines a double-D shaped fixing hole 22, receiving the combination block 16 of the shaft 10.

The rotation bracket 30 includes a combination portion 32. The combination portion 32 includes a first end surface 34 facing the interference element 40 and a second end surface 36 opposite to the first end surface 34. A round through hole 38 is defined in a center of the combination portion 32, through the first end surface 34 and the second surface 36, through which the fixing rod 12 of the shaft 10 passes. The first end surface 34 is located on a first cone angling down from a side to a center of the first end surface 34. The first end surface 34 symmetrically defines two depressed portions 340. A underside of each depressed portion 340 is located on a second cone angling down from the side to the center of the first end surface 34. In one embodiment, a taper of the first cone is equal to a taper of the second cone.

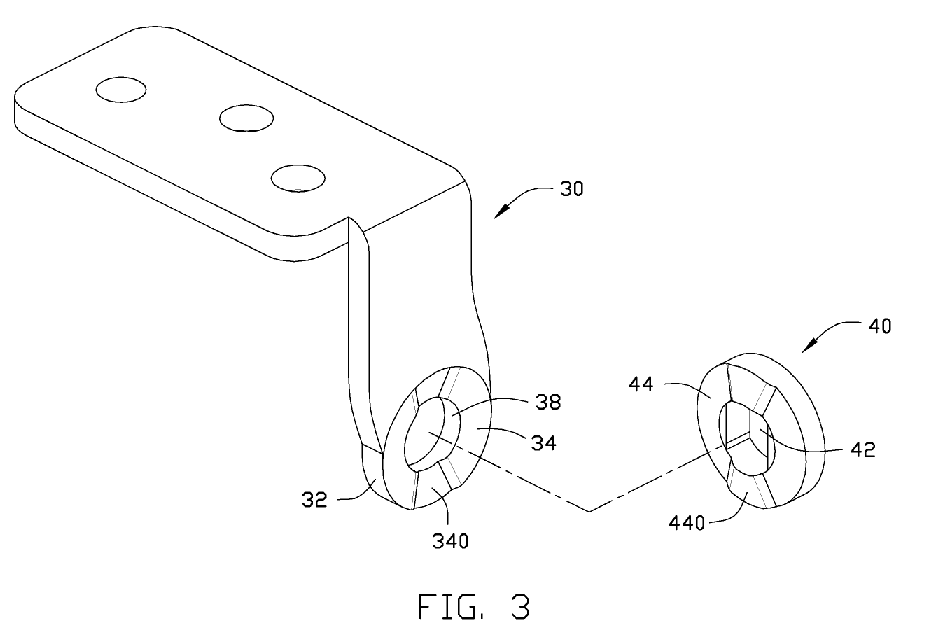

Referring to FIG. 3, the interference element 40 includes a first end surface 44 facing the combination portion 32 of the rotation bracket 30 and a second surface 46 opposite to the first surface 44. A double-D shaped through hole 42 is defined in a center of the interference element 40, through the first end surface 44 and the second surface 46, through which the fixing rod 12 of the shaft 10 passes. The first end surface 44 is located on a third cone angling down from a center to a side of the first end surface 44. Two raised portions 440 protrude symmetrically from the first end surface 44 across the through hole 42. A top of each raised portion 440 is located on a fourth cone angling down from the center to the side of the first end surface 44. In one embodiment, a taper of each of the third cone and the fourth cone is equal to the taper of the first cone.

The biasing member 50 includes a plurality of elastic elements horizontally stacked together, and each of the plurality of elastic elements defines a through hole 52 through which the fixing rod 12 of the shaft 10 passes.

Each washer 60 defines a double-D shaped through hole 62 in a center thereof, through which the fixing rod 12 of the shaft 10 passes.

In one embodiment, the fastener 70 is a screw cap.

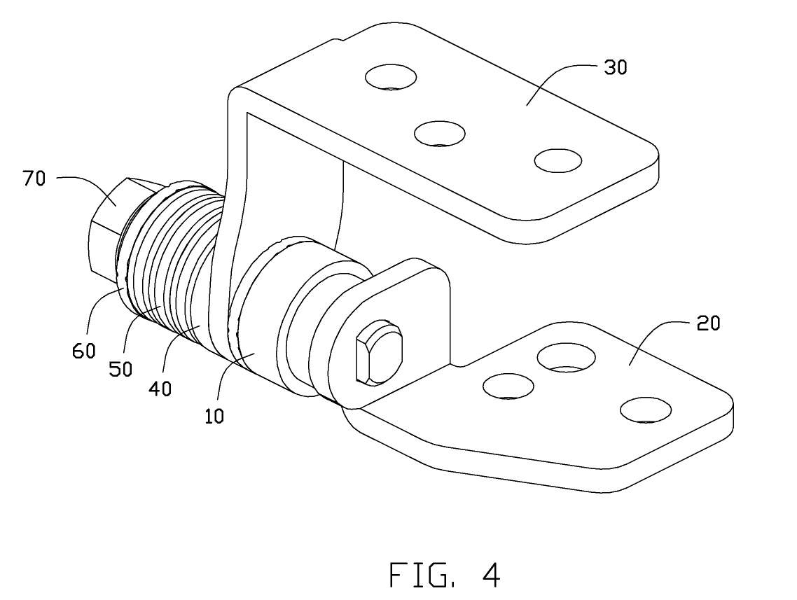

Referring to FIG. 4, during assembly, the combination block 16 of the shaft 10 is received and fixed in the fixing hole 22 of the fixing bracket 20, such that the shaft 10 can rotate together with the first bracket 20. The fixing rod 12 passes though the through hole 62 of one washer 60, the through hole 38 of the rotation bracket 30, the through hole 42 of the interference element 40, the through holes 52 of the plurality of elastic elements of the biasing member 50, and the through hole 62 of the other washer 60 in that order. The fastener 70 engages the threaded portion 120, to prevent the washer 80 from resisting the biasing member 50, and the biasing member 50 from disengaging from the shaft 10, and maintain constant contact between the interference element 40 and the combination portion 32. The washer 60 resists the protrusion 14 of the shaft 10 and the rotation bracket 30 increases friction between the protrusion 14 and the rotation bracket 30. The raised portions 440 of the interference element 40 engage the corresponding depressed portions 340 of the interference element 30.

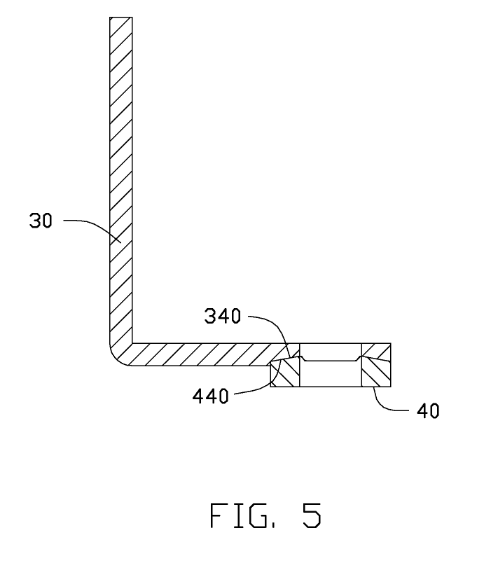

Referring to FIG. 5, in use, the fixing bracket 20 is fixed to a first part of a collapsible device, such as a notebook computer, and the rotation bracket 30 is fixed to a second part of the collapsible device. When the first part is rotated relative to the second part, the fixing bracket 20 is rotated with the first part and the shaft 10 rotates together with the fixing bracket 20, such that the interference element 40 fixed to the fixing rod 12 of the shaft 10 can rotate together with the shaft 10. When the raised portions 440 of the interference element 40 engage the depressed portions 340 of the rotation bracket 30, the hinge is in a locked state, the first end surface 34 of the combination portion 32 resists and the first end surface 44 of the interference element 4, and the tops of the corresponding raised portions 440 resist the undersides of the corresponding depressed portions 340. The interference element 40 is thus in constant contact with the combination portion 34, applying a force radially on the hinge, due to engagement between the first and second cones and between the third and fourth cones, to avoid eccentricity and vibration of the hinge.

Rotating the fixing bracket 20, the raised portions 440 of the interference element 40 move out from the depressed portions 340 of the rotation bracket 30, the raised portions 440 of the interference element 40 are rotatable in constant contact with the first end surface 34 of the combination portion 32, applying a force radially on the hinge due to engagement between the first end surface 34 of the combination portion 32 and the raised portion 440 of the interference element 40, to avoid eccentricity and vibration of the hinge.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hinge comprising,
a shaft;
a rotation bracket rotatably mounted to the shaft;
an interference element fixedly mounted to the shaft;
a biasing member mounted to the shaft; and
a fastener fixed to the shaft, to prevent the interference element, the rotation bracket, and the biasing member from disengaging from the shaft, wherein the rotation bracket comprises a combination portion, the interference element comprises a first end surface located on a first cone angling down from a center towards a side of the first end surface, the combination portion comprises a second end surface located on a second cone angling down from a side towards a center of the second end surface, to engage with and capable of rotating relative to the first end surface of the interference element.

2. The hinge of claim 1, wherein the center of each of the interference element and combination portion respectively defines a through hole for the shaft passing through.

3. The hinge of claim 2, wherein the first end surface of the interference element symmetrically forms two raised portions across the through hole of the interference element, and the second end surface of the combination portion symmetrically defines two depressed portions across the through hole of the combination portion, to engage with the corresponding raised portions.

4. The hinge of claim 3, wherein a top of each raised portion is located on a third cone angling down from the center towards the side of the first end surface, and a underside of each depressed portion is located on a fourth cone angling down from the side towards the center of the second end surface.

5. The hinge of claim 4, wherein a taper of the third cone is equal to a taper of the fourth cone.

6. The hinge of claim 5, wherein a taper of each of the first and second cones is equal to the taper of the third cone.

7. The hinge of claim 1, wherein a taper of the first cone is equal to a taper of the second cone.

8. The hinge of claim 1, wherein the biasing member includes a plurality of elastic elements horizontally stacked together, and each of the plurality of elastic elements defines a through hole through which the fixing rod of the shaft passes.
